(19) United States
(12) Patent Application Publication
(10) Pub. No.: US 2009/0109501 A1
(43) Pub. Date: Apr. 30, 2009

(54) CONTACT IMAGE SENSOR AND IMAGE FORMING APPARATUS

(75) Inventors: Katsuya NAGAMOCHI, Tokyo (JP); Sueo UENO, Shizuoka-ken (JP); Kunihiko MIURA, Kanagawa-ken (JP)

Correspondence Address: PATTERSON & SHERIDAN, L.L.P., 3040 POST OAK BOULEVARD, SUITE 1500, HOUSTON, TX, 77056, US

(73) Assignees: KABUSHIKI KAISHA TOSHIBA, Tokyo (JP); TOSHIBA TEC KABUSHIKI KAISHA, Tokyo (JP)

(21) Appl. No.: 12/249,651

(22) Filed: Oct. 10, 2008

(30) Foreign Application Priority Data
Oct. 29, 2007 (JP) 2007-279846

(51) Int. Cl. H04N 1/04

(52) U.S. Cl. 358/475

(57) ABSTRACT

A contact image sensor comprises a housing, a light source provided on the upper part of the housing to irradiate light to a document, lenses arranged in the housing and provided at least on an entering side and an outgoing side to focus reflected light from a reading position of the document, an aperture angle regulation member having an inclined surface to reflect a part of light irradiated from the light source at the reading position of the document and an aperture portion into which the reflected light enters directly to regulate an aperture angle to permit the reflected light passing through the aperture portion to be irradiated to the lens on the entering side, and a light receiving element array to receive and photoelectrically convert the reflected light focused after passing through the lenses.

### CROSS-REFERENCE TO RELATED APPLICATION

This application is based upon and claims the benefit of priority from the prior Japanese Patent Application No. 2007-279846, filed on Oct. 29, 2007; the entire contents of all of which are incorporated herein by reference.

### FIELD OF THE INVENTION

The present invention relates to a contact image sensor and an image forming apparatus.

### DESCRIPTION OF THE BACKGROUND

As an optical imaging system used for a mechanism for reading an image such as an image scanner, there are a contracted optical system for forming a document image contracted by a lens and an equimultiple optical system for forming a document image which is equimultiple to the document. The line image sensor of the contracted optical system is characterized in that the depth of focus is large because the lens is used, and a portion of the document separated from the document table such as a fold of the document can be read, though the body size is increased due to the structure.

On the other hand, the contact image sensor which is an equimultiple optical system, compared with the line image sensor of the contracted optical system, since few parts are used and the sensor which is an optical component and the lens array can be arranged close to each other, can be designed comparatively thinly. Therefore, the contact image sensor, in an image reading device such as an image scanner, a facsimile, or a copying machine, is conventionally used widely as an image reading unit for reading an image (for example, refer to Japanese Patent Application Publication No. 10-173862).

FIG. 1 is a cross sectional view schematically showing the structure of the image reading device disclosed in Japanese Patent Application Publication No. 10-173862 as a related art. An image reading device 200 is a light source for irradiating light to a document 201 and is composed of an LED array 202 which is a linear light source extending in the main scanning direction (in the depth direction of FIG. 1), a transparent plate 203 for loading the document 201, a rod lens array 204 extended in the main scanning direction for focusing the light reflected at an image reading position A of the document 201 and forming an image, a sensor IC 205 in which a plurality of light receiving elements for photoelectrically converting and detecting the image of the document 201 formed by the rod lens array 204 are arranged in the main scanning direction, and a frame 206 for supporting these members. The LED array 202, rod lens array 204, sensor IC 205, and frame 206 compose a contact image sensor 207.

The image reading device 200 having the contact image sensor 207 is an equimultiple optical system, so that it is characterized in that the depth of focus is small and the aperture angle (the view angle of the lens) inversely proportional to the depth of focus is large. Namely, the rod lens array 204 permits the reading light reflected from the document 201 to enter at a wide angle. The LED array 202, to permit isolation and creases of the document 201, irradiates a certain fixed range in the neighborhood of the image reading portion A. Therefore, a large quantity of stray light causing deterioration of a read image such as a ghost image is generated. To suppress it, the rod lens array 204 is arranged at a position closer to the document 201 than the LED array 202.

In place of the rod lens array 204, to increase the transfer quantity of the light quantity of the lens and reduce transmitted light quantity irregularities, it is well known to structure an upright equimultiple lens array using a resin lens plate in which a plurality of minute convex lenses are regularly arranged two-dimensionally at a predetermined pitch on its surface (for example, refer to Japanese Patent Application Publication No. 2005-37891).

However, in the aforementioned conventional constitution of the image reading device 200, the rod lens array 204 is closer to the document 201 than the LED array 202, so that the light irradiated from the LED array 202 toward the document 201, for example, as shown by an arrow L, is irradiated also to the side surface portion of the rod lens array 204. The light irradiated to the side surface portion of the rod lens array 204, depending on the quality of the material and surface condition of the side surface portion, reflects or reflects irregularly in a direction off the image reading position A to turbulent light or is absorbed, so that the light quantity entering the rod lens array 204 is reduced, thus a problem arises that the received light quantity of the sensor IC 205 is reduced. If the received light quantity of the sensor IC 205 is reduced, for example, when reading a linear image such as ruled lines, image noise such as a color shade difference or a gray background of the image occurs, causing deterioration of the quality of the image.

On the other hand, as a means for increasing the received light quantity of the sensor IC 205 which is a light receiving element array, it may be considered to increase the number of light sources of the LED array 202 or change the light source to a light source of high light emission efficiency, though these means cause an increase in cost, shortening of the life span of the light source due to an increase in the light quantity output of the light source, increasing in the power consumption, and necessity of a countermeasure for heat radiation for the generated heat.

### SUMMARY OF THE INVENTION

The present invention was developed with the foregoing in view and is intended to provide a contact image sensor capable of ensuring the received light quantity of the light receiving element array without increasing the light quantity of the light source and an image forming apparatus for loading the image reading device of the contact image sensor.

A contact image sensor is provided in an embodiment of the present invention and the contact image sensor comprises a housing; a light source provided on the upper part of the housing to irradiate light to a document; lenses arranged in the housing and provided at least on an entering side and an outgoing side to focus reflected light from a reading position of the document; an aperture angle regulation member having an inclined surface to reflect a part of light irradiated from the light source at the reading position of the document and an aperture portion into which the reflected light enters directly to regulate an aperture angle to permit the reflected light passing through the aperture portion to be irradiated to the lens on the entering side; and a light receiving element array to receive and photoelectrically convert the reflected light focused after passing through the lenses.

Further, an image forming apparatus is provided in an embodiment of the present invention and the apparatus comprises an image reading device including a housing, a light source provided on an upper part of the housing to irradiate light to a document, lenses arranged in the housing at least on an entering side and an outgoing side to focus reflected light from a reading position of the document, an aperture angle regulation member having an inclined surface to reflect a part of light irradiated from the light source at the document reading position and an aperture portion to permit the reflected light to enter directly to regulate an aperture angle to permit the reflected light passing through the aperture portion to be irradiated to the lens on the entering side, and a light receiving element array to receive and photoelectrically convert the reflected light focused after passing through the lenses; a sheet supply portion to store sheets; an image forming portion to form an image read by the image reading device on a sheet supplied from the sheet supply portion; and a sheet discharge portion to discharge the sheet with the image formed.

Further, an image reading method of a contact image sensor and the method comprises irradiating light from a light source toward a document reading position; focusing reflected light from the document reading position via lenses installed at least on an entering side and an outgoing side; leading the light from the light source directly to the document reading portion, and reflecting a part of the light from the light source on a inclined surface, which is formed on aperture angle regulation member having an aperture portion to permit the reflected light from the document to enter directly to regulate an aperture angel to permit the reflected light to be irradiated to the lens on the entering side, to lead the light to the document reading portion; and receiving and photoelectrically converting the reflected light focused when the light led to the document reading position is reflected and passes through the lenses by a light receiving element array.

### BRIEF DESCRIPTION OF THE DRAWINGS

FIG. 1 is a cross sectional view schematically showing the structure of a conventional image reading device;

FIG. 2 is a perspective view showing the outline of the image forming apparatus having the contact image sensor relating to the first embodiment of the present invention;

FIG. 3 is a cross sectional view showing the schematic constitution of the image forming apparatus relating to the same embodiment and the automatic document feeder installed optionally on the image forming apparatus;

FIG. 4 is a cross sectional view showing the schematic constitution of the image reading device relating to the same embodiment;

FIG. 5 is a perspective view showing the outline of the aperture angle regulation member relating to the same embodiment;

FIG. 6 is a drawing showing the light intensity distribution at the position on a glass plate 2 in the sub-scanning direction relating to the same embodiment;

FIG. 7 is a cross sectional view showing the schematic constitution of the image reading device relating to the second embodiment of the present invention;

FIG. 8 is a drawing showing the light intensity distribution at the position on the glass plate 2 in the sub-scanning direction relating to the same embodiment;

FIG. 9 is a cross sectional view showing the schematic constitution of the image reading device relating to the third embodiment of the present invention;

FIG. 10 is a plan view of a micro-lens plate 14a viewed in the focal direction of the lens;

FIG. 11 is a cross sectional view showing the schematic constitution of the image reading device relating to the fourth embodiment of the present invention.

### DETAILED DESCRIPTION OF THE INVENTION

Hereinafter, the first to fourth embodiments of the present invention will be explained.

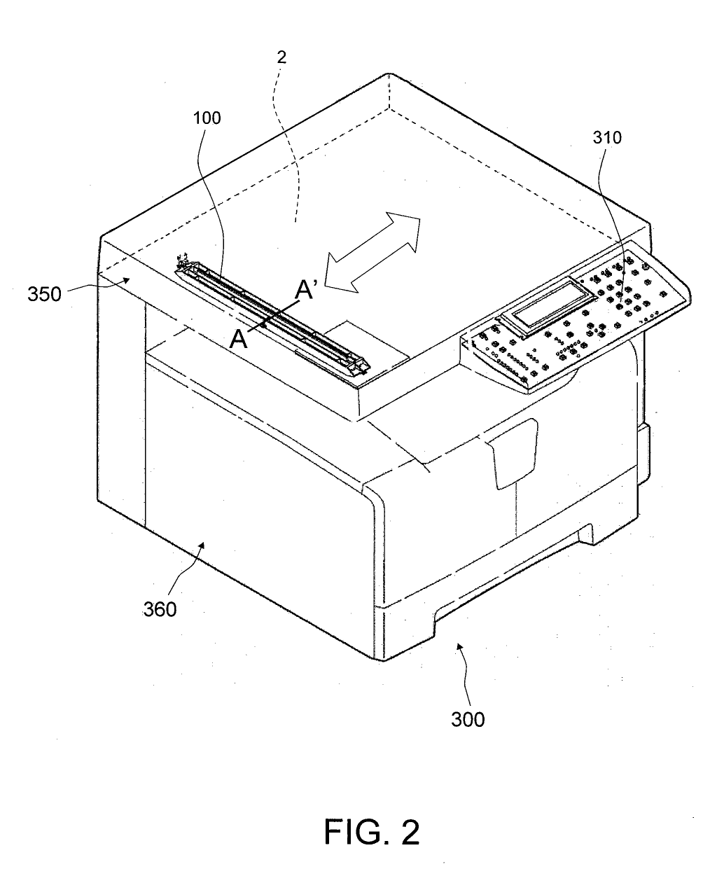

(First embodiment) Hereinafter, the first embodiment of the present invention will be explained. FIG. 2 is a perspective view showing the outline of the image forming apparatus having the contact image sensor relating to the first embodiment of the present invention. An image forming apparatus 300 is composed of an image reading device 350 and an image printing apparatus 360. The image reading device 350 reads an image of a document loaded on the glass plate 2 according of an operation of an operation panel 310 using a contact image sensor 100. The image printing apparatus 360 prints and outputs the image read by the image reading device 350 onto a sheet (not shown).

When reading the image of the document, the contact image sensor 100 which is a linear sensor reads the document image in correspondence to one line in the longitudinal direction (the main scanning direction). When the one-line reading is finished, the contact image sensor 100 moves the document image in the direction of the void arrow (the sub-scanning direction) perpendicular to the main scanning direction and then reads the document image in correspondence to the next one line. The contact image sensor 100 executes the process for overall the document size, thereby completes the reading of the one-page document. The cross sectional view of the contact image sensor 100 on the line A-A′ will be explained later by referring to the drawing.

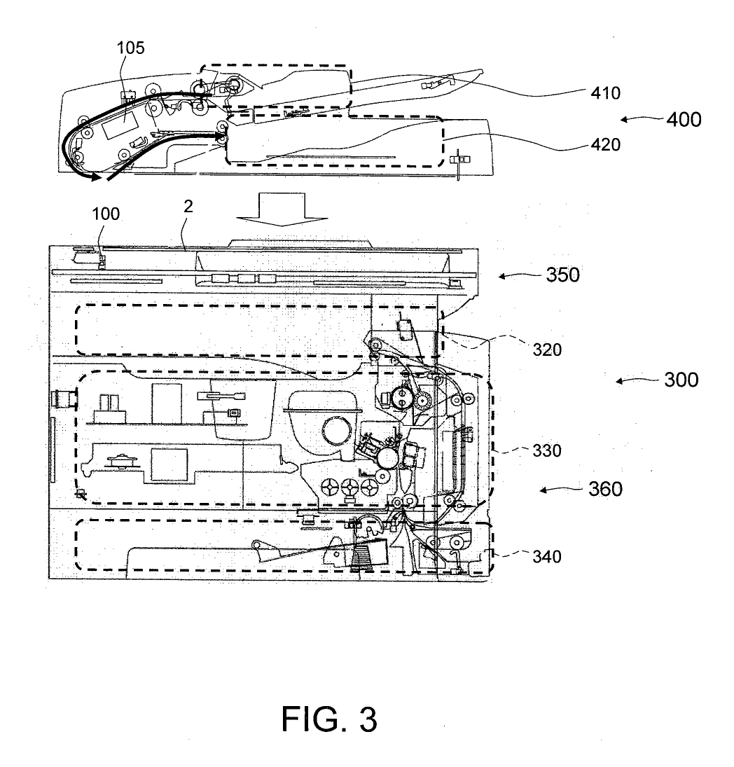

FIG. 3 is a cross sectional view showing the schematic constitution of the image forming apparatus 300 and an automatic document feeder 400 installed optionally on the image forming apparatus 300. The image reading device 350 of the image forming apparatus 300 is supplied with sheets by the automatic document feeder 400 and reads an image of a document loaded on the glass plate 2 by the contact image sensor 100. The image printing apparatus 360 firstly takes out sheets stacked on the sheet supply portion 340 one by one and sends it to the image forming portion 330. And, the image forming portion 330 forms and prints the image read by the image reading device 350 on the sheet supplied. Furthermore, the sheet on which the image is printed by the image forming portion 330 is ejected to the sheet ejection portion 320.

The automatic document feeder 400 takes out documents loaded on a document feeding portion 410 one by one, conveys it along the arrow, and ejects it to a document ejection portion 420. In this case, each document is conveyed in the sub-scanning direction on the contact image sensor 100 installed halfway on the conveying path, so that the contact image sensor 100 does not move in the sub-scanning direction aforementioned and reads the document in the standstill state. It is possible to install a contact image sensor 105 in the automatic document feeder 400 and use a constitution that both sides of the document are read by the contact image sensors 100 and 105 installed halfway on the conveying path.

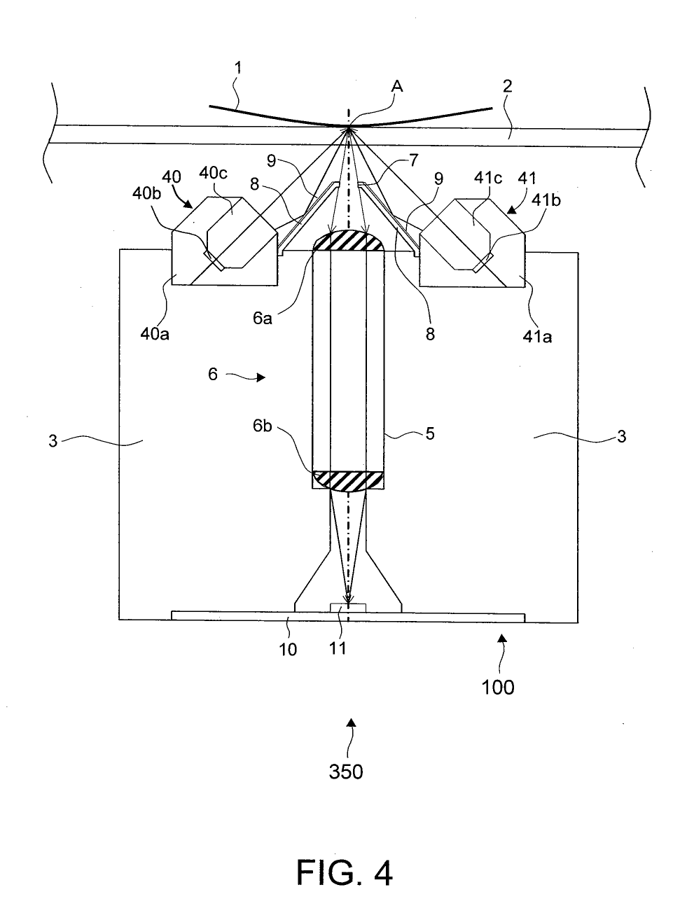

FIG. 4 is a cross sectional view on the line A-A of the image reading device 350 shown in FIG. 2 and shows a schematic constitution of the image reading device 350. The image reading device 350 is composed of the contact image sensor 100 and glass plate 2. The contact image sensor 100 reads an image of a document 1 on the glass plate 2 on the surface opposite to the glass plate 2. By referring to the drawing, the constitution of the contact image sensor 100 will be explained below.

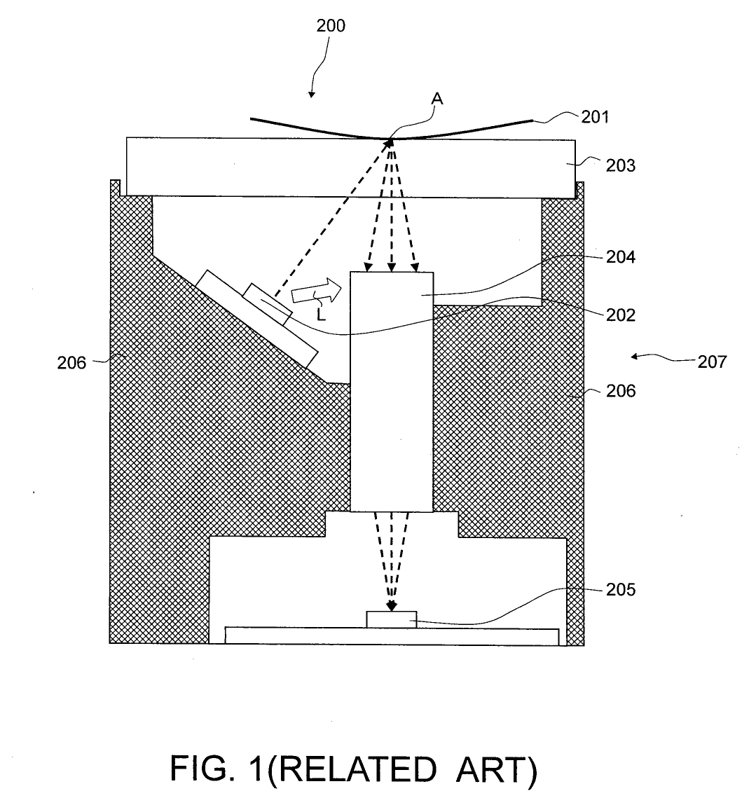

The contact image sensor 100 has a housing 3. On the top surface of the housing 3 on the side of the glass plate 2, two LED line flares 40 and 41 for irradiating light toward the image reading position A of the document 1 are installed so as to extend in the main scanning direction(in the depth direction shown in FIG. 4). The LED line flare 40 has an LED array 40b which is a linear light source and a light guide member 40c in the concavity of a lighting case 40a. Similarly, the LED line flare 41 has an LED array 41b which is a linear light source and a light guide member 41c in the concavity of a lighting case 41a. LED arrays 40b and 41b may be adapted to irradiate directly the document 1 without the light guide members 40c and 41c as shown as the LED array 202 in FIG. 1. The light sources are not limited to an LED and may be a fluorescent tube, a xenon tube, a cold cathode tube, or an organic EL.

The LED line flare 40 may be structured so as to include the light guide member 41c in the concavity of the lighting case 41a, an LED chip (not shown) installed at the end of the light guide member 41c in the main scanning direction (in the depth direction), and a reflection plate (not shown) for reflecting light irradiated from the LED chip which may be replaced with the LED array 40b. The reflection plate is arranged so that light irradiated from the LED chip arranged at the end of the light guide member 41c is irradiated in a uniform light distribution on the light emission surface of the light guide member 41c. The LED line flares 40 and 41 may have a different constitution or may output a different light quantity, though in this embodiment, the case that the two have the same constitution and output the same light quantity will be explained.

Between the LED line flares 40 and 41 of the housing 3, a groove 5 which is dug in the with direction of the housing 3 (in the direction of separating from the glass plate 2) and is extended in the main scanning direction is formed. At least on the entering side and outgoing side of the groove 5, cylindrical lens 6a and 6b (hereinafter, referred to as together cylindrical lenses 6) are installed. The cylindrical lenses 6 have a semicircular cylindrical surface (the curved line shown in the drawing) extending in the main scanning direction and a plane (the straight line shown in the drawing) and have power only in the sub-scanning direction (in the transverse direction of FIG. 4). The cylindrical lenses 6, since the semicircular cylindrical surface side of the cylindrical lens 6a on the side of the glass plate 2 (the entering side) is arranged toward the glass plate 2 and the semicircular cylindrical surface side of the cylindrical lens 6b on the side of a light receiving element array 11 (the outgoing side) is arranged toward the light receiving element array 11, functions as an upright equimultiple lens array.

On the top surface of the housing 3, an aperture angle regulation member 8 having a slip portion 7 for covering the cylindrical lens 6a is installed. The preparation process of the contact image sensor 100 firstly inserts the cylindrical lens 6 into the groove 5, positions and fixes the cylindrical lens 6, and installs the aperture angle regulation member 8 so as to cover the cylindrical lens 6a. Therefore, the position of the cylindrical lens 6 can be adjusted.

The aperture angle regulation member 8 has an inclined surface 9 inclined from the side of the side surfaces of the LED line flares 40 and 41 opposite to each other toward the side of the cylindrical lens 6a. On the outer surface of the aperture angle regulation member 8 forming the inclined surface 9, so that the light irradiated from the LED line flares 40 and 41 is reflected to the image reading position A by the inclined surface 9 of the aperture angle regulation member 8, a mirrored surface portion 9a is installed. The mirrored surface portion 9a reflects normally the incident light (the incident angle and reflection angle of the light with the reflection surface are the same) and leads it to the image reading position A. The two aperture angle regulation members 8 have the inclined surface 9 (on the left) for reflecting a part of the light irradiated from the LED line flare 40 to the document reading position A, the inclined surface 9 (on the right) for reflecting a part of the light irradiated from the LED line flare 41 to the document reading position A, and a slit portion 7 installed between the two inclined surfaces 9 through which the reflected light enters directly. And, the two aperture angle regulation members 8 regulate the aperture angle at which the reflected light passing through the slit portion 7 is irradiated to the cylindrical lens 6a on the entering side thereof.

At the bottom of the housing 3, a substrate 10 on which electronic parts are mounted and wired is installed. On the substrate 10, at the position almost coinciding with the optical axis of the cylindrical lens 6b, the light receiving element array 11 composed of a plurality of photoelectric conversion devices (for example, CCD elements) arranged in the main scanning direction is installed.

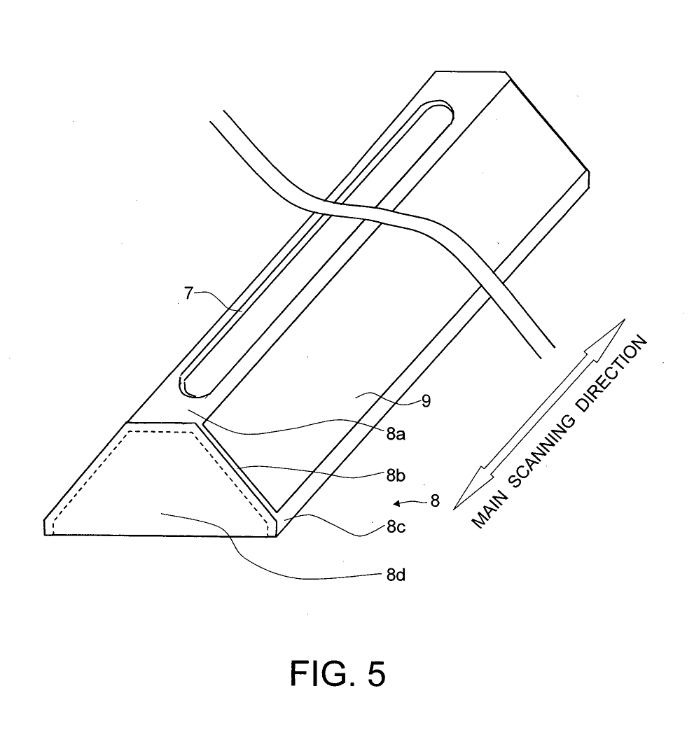

FIG. 5 is a perspective view showing the outline of the aperture angle regulation member 8. The aperture angle regulation member 8 is composed of, for example, a metallic flat plate haying a black-alumite-treated surface extending in the main scanning direction. The flat plate is folded so that the section perpendicular to the main scanning direction is in a conical shape and on the top surface portion 8a composing the top of the conical shape, the opened slit portion 7 is formed. On an inclined surface portion 8b (the other surface is not shown) composing the inclined surfaces 9 on both sides of the conical shape, the mirrored surface portion 9a is installed. The inclined surface portion 8b covers at least a part of the cylindrical lens 6a.

Lower portions 8c on both sides of the aperture angle regulation member 8 are installed between the cylindrical lens 6a and the LED line flares 40 and 41. At both ends of the aperture angle regulation member 8 in the longitudinal direction, to prevent light from entering internally from other than the slit portion 7, cover portions 8d (the opposite cover portion is not shown) which are similarly black-alumite-treated are installed.

Next, by referring to FIG. 4, the operation of the contact image sensor 100 will be explained. Light is irradiated to the document by the LED line flares 40 and 41 and the reflected light reflected at the image reading position A of the document surface enters the cylindrical lens 6a via the slit portion 7 of the aperture angle regulation member 8. At this time, a part of the light irradiated from the LED line flares 40 and 41 is reflected by the mirrored surface portion 9a of the aperture angle regulation member 8 and is irradiated to the image reading position A. The reflected light having intensity according to a color image which is reflected at the image reading position A enters the cylindrical lens 6a via the slit portion 7 of the aperture angle regulation member 8. Therefore, the aperture angle which is a view angle of the lens is regulated and the depth of focus of the cylindrical lens 6a is increased.

The cylindrical lens 6 has power in the sub-scanning direction, so that the light entering the semicircular cylindrical surface of the cylindrical lens 6a is outputted in parallel with the optical axis of the lens. Thereafter, the light entering the cylindrical lens 6a is emitted from the semicircular cylindrical surface of the cylindrical lens 6b and is focused on the light receiving element array 11.

The focused light is converted to an electric signal by the photoelectric conversion device composing the light receiving element array 11. As for this electric signal, signal processing such as signal amplification and digital change processing, is performed. The electric signal by which signal processing was carried out is transmitted to the memory section (not shown) on the substrate 10 or the memory section (not shown) on another substrate connected with the substrate 10 via the signal transmitting means such as harness.

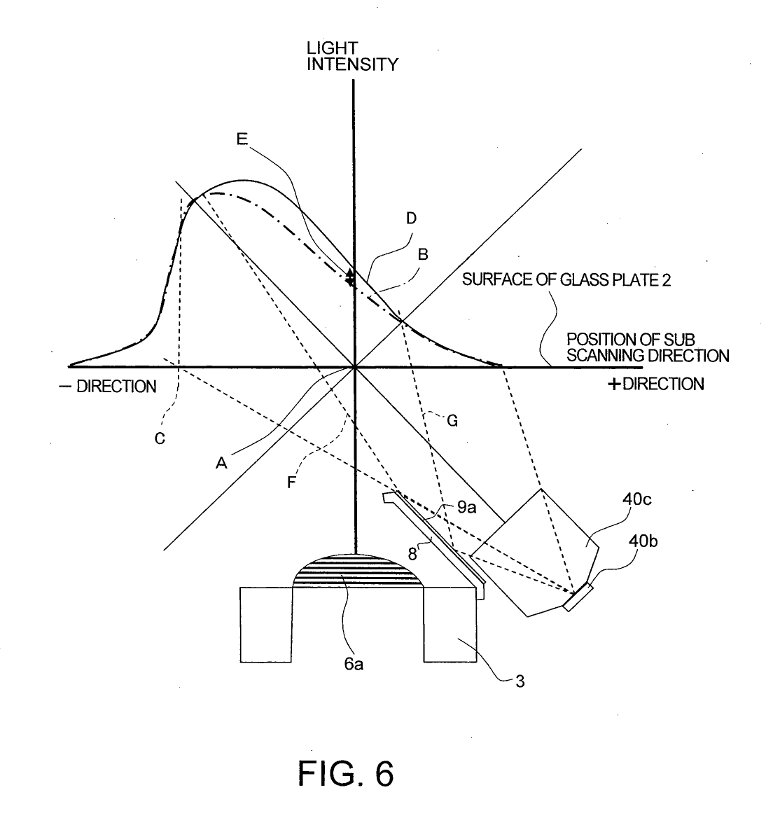

FIG. 6 is a drawing showing the light intensity distribution at the position on the glass plate 2 in the sub-scanning direction when the aperture angle regulation member 8 is equipped with the mirrored surface portion 9a or not. For example, the light irradiated from the LED array 40b is irradiated to the image reading position A of the glass plate 2 via the light guide member 40c. The LED array 40b is installed so that the light irradiated from the light guide member 40c has high directivity toward the image reading position A which is almost an intersection point between the optical axis of the cylindrical lens 6a and the surface of the glass plate 2.

An alternate long and short dash line B shown in FIG. 6 indicates a light intensity distribution when the mirrored surface portion 9a is not installed in the aperture angle regulation member 8. The LED array 40b has high directivity toward the image reading position A, so that it indicates highest light intensity on the straight line connecting the LED array 40b and the image reading position A. Further, among the light from the LED array 40b, the light irradiated to the aperture angle regulation member 8 is interrupted its optical path, so that actually, the light intensity distribution in one direction of a dotted line C is lost.

On the other hand, a solid line D shown in FIG. 6 indicates a light intensity distribution when the mirrored surface portion 9a is installed in the aperture angle regulation member 8. The light irradiated toward the aperture angle regulation member 8, when the mirrored surface portion 9a is not installed, is absorbed, though if the mirrored surface portion 9a is installed, as shown by dotted lines F and G, it is reflected normally. Therefore, within the range indicated by the dotted lines F and G, the light due to the reflected light is increased and the light intensity at the image reading position A is increased from that of the alternate long and short dash line B by the value in correspondence to a difference E.

Namely, the intensity of the light entering the cylindrical lens 6a, if the mirrored surface portion 9a is installed on the outer surface of the aperture angle regulation member 8, is increased by the value in correspondence to the difference E.

As explained above, according to the contact image sensor relating to this embodiment, the following effects can be obtained.

(1) The reflected light reflected at the image reading position A of the document 1 enters the cylindrical lens 6a via the slit portion 7 of the aperture angle regulation member 8, so that the aperture angle of the cylindrical lens 6a is regulated. Therefore, by use of only the light passing the neighborhood of the optical axis of the cylindrical lens 6a, the depth of focus can be increased, and the deterioration of a read image due to isolation of the document is suppressed, thus the image quality can be improved.

(2) By the inclined surface portion 8b of the aperture angle regulation member 8, the light irradiated from the LED line flare 40 to the image reading position A is prevented from obstruction and an occurrence of turbulent light can be prevented.

(3) The mirrored surface portion 9a installed in the inclined surface portion 8b of the aperture angle regulation member 8 leads a part of the light irradiated from the LED line flare 40 to the image reading position A, so that the light which will be turbulent light can be irradiated to the image reading position A. Therefore, the light quantity which is reflected at the image reading position A and enters the cylindrical lens 6a is increased. Namely, the light receiving quantity of the light receiving element array 11 is increased, and an occurrence of image noise can be suppressed, so that the image quality can be improved.

(4) By use of a simple constitution of adopting the aperture angle regulation member 8 having the inclined surface 9, without increasing the light quantities of the LED line flares 40 and 41, the effects described in (1) to (3) can be produced simultaneously.

(Second embodiment) Next, the second embodiment of the present invention will be explained. In the image reading device relating to this embodiment, the basic structure is based on the image reading device 350 of the first embodiment. However, a contact image sensor 110 relating to this embodiment is different in the respect that as “a plurality of lenses”, two lens arrays composed of lenses arranged in a one-row array shape in the main scanning direction are stacked in the focal direction of the lens and are structured as an upside-down equimultiple lens and the respect that an irregular reflection portion 13 is used as a “reflection member”.

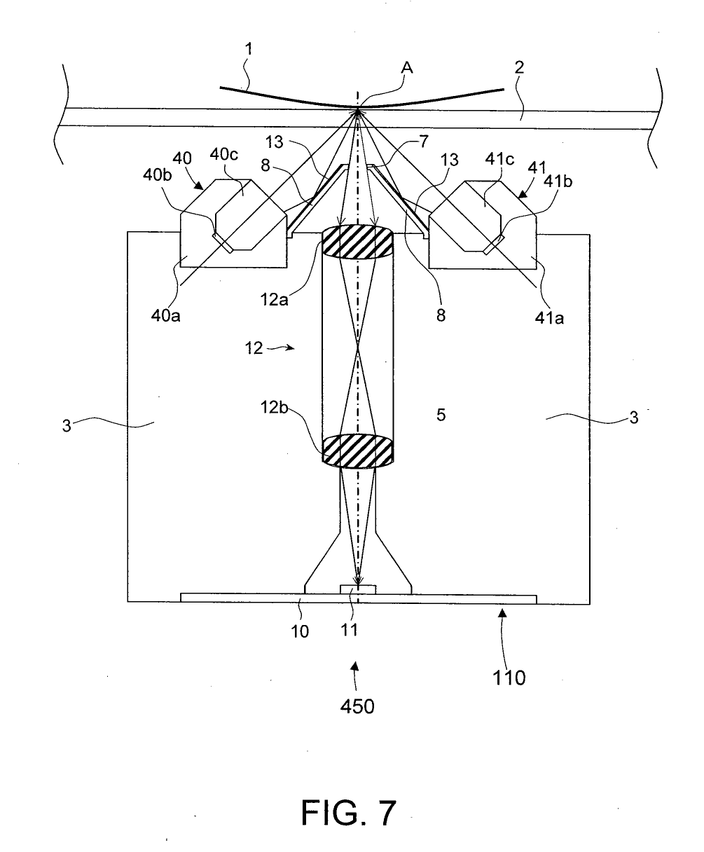

FIG. 7 is a cross sectional view showing the schematic constitution of the image reading device relating to the second embodiment of the present invention. By referring to the drawing, the constitution of the contact image sensor 110 will be explained below. Further, to the components similar to and based on those of the first embodiment, the same numerals are assigned and the detailed explanation will be omitted.

The contact image sensor 110, in the groove 5 formed in the housing 3, includes a lens array 12a which is installed on the side of the glass plate 2 and is composed of lenses arranged in a one-row array shape in the main scanning direction and a lens array 12b which is installed on the side of the light receiving element array 11 and is composed of lenses arranged in a one-row array shape in the main scanning direction. On the inclined surface 9 of the aperture angle regulation member 8, the irregular reflection portion 13 for irregularly reflecting a part of the light irradiated from the LED line flare 4 to the image reading position A of the document 1 is installed.

The reflection surface of the irregular reflection portion 13 is subjected to the sandblast process of blasting fine nonmetallic and metallic particles at high speed to form fine uneven parts and to rough the mirror surface. By doing this, the uneven parts formed on the reflection surface are larger than the wave length of the light, so that the light irradiated to the irregular reflection portion 13 is reflected irregularly.

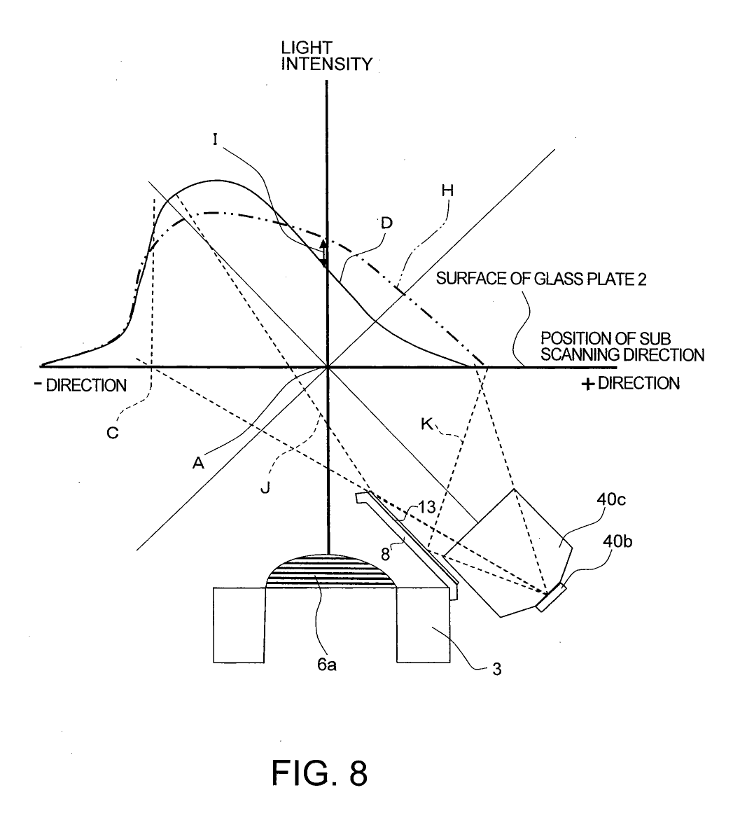

FIG. 8 is a drawing showing the light intensity distribution at the position on the glass plate 2 in the sub-scanning direction when the mirrored surface portion 9a or the irregular reflection portion 13 is installed in the aperture angle regulation member 8. The solid line D indicates a light intensity distribution (the same as that shown in FIG. 6) when the mirrored surface portion 9a is installed in the aperture angle regulation member 8. On the other hand, a two-dot chain line H indicates a light intensity distribution when the irregular reflection portion 13 is installed in the aperture angle regulation member 8.

The light irradiated to the aperture angle regulation member 8, when the irregular reflection portion 13 is installed, is reflected irregularly as shown by dotted lines L and K. By doing this, in the wide range indicated by the dotted lines J and K, the light due to the irregularly reflected light is increased uniformly, so that the light intensity at the image reading position A is increased than a curve D by the value in correspondence to a difference I.

Namely, the intensity of the light entering the cylindrical lens 6a, since the irregular reflection portion 13 is installed on the inclined surface 9 of the aperture angle regulation member 8, is increased than that when the mirrored surface portion 9a is installed additionally by the value in correspondence to the difference I.

Here, according to this embodiment, the reflection surface of the irregular reflection portion 13 is roughed by the sandblast process, though the present invention is not limited to it, and by the blast process of blasting nonmetallic and metallic particles at high speed to rough the surface or the electrical discharge machining of roughing the surface by discharge, an irregular reflection surface may be formed.

As explained above, by the contact image sensor (image reading device) relating to this embodiment, the following effects can be obtained.

(5) The irregular reflection portion 13 installed on the inclined surface 9 of the aperture angle regulation member 8 reflects irregularly and leads a part of the light irradiated from the LED line flare 4 to the image reading position A, so that the light which will be turbulent light can be irradiated to the image reading position A. The irregular reflection portion 13 reflects irregularly (diffused reflection) the irradiated light, so that the reflected light from the irregular reflection portion 13 can be irradiated uniformly within a wide range. Therefore, the light quantity which is reflected at the image reading position A and enters the cylindrical lens 6a is increased. Namely, the light receiving quantity of the light receiving element array 11 is increased, and an occurrence of image noise can be suppressed, so that the image quality can be improved.

(Third embodiment) Next, the third embodiment of the present invention will be explained. In the image reading device relating to this embodiment, the basic structure is based on the image reading devices 350 and 450 of the first and second embodiments. However, a contact image sensor 120 relating to this embodiment is different in the respect that as “a plurality of lenses”, a micro-lens array which will be described later is used.

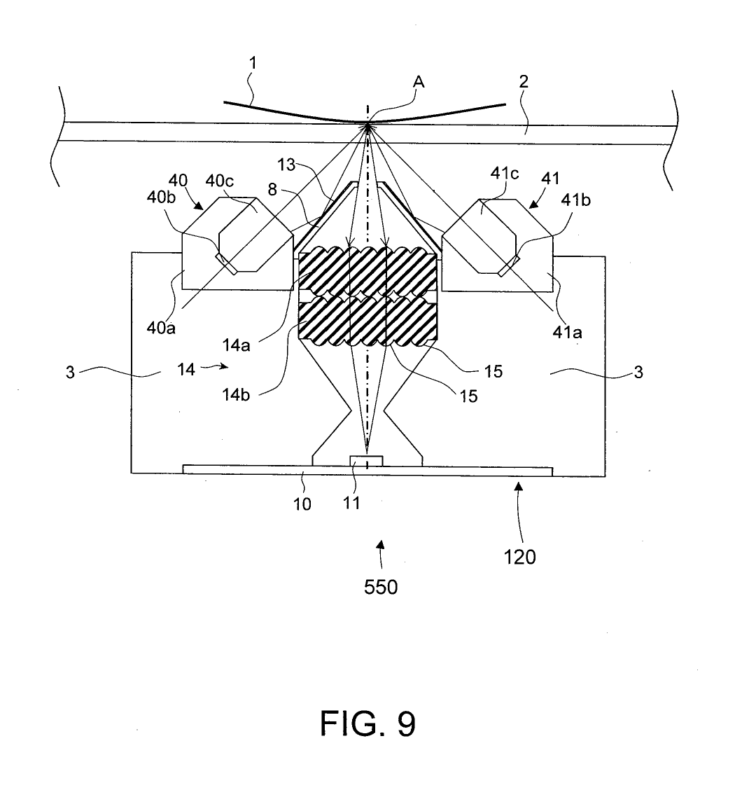

FIG. 9 is a cross sectional view showing the schematic constitution of an image reading device 550 relating to the third embodiment of the present invention. By referring to the drawing, the constitution of the contact image sensor 120 will be explained below. Further, to the components similar to and based on those of the first embodiment, the same numerals are assigned and the detailed explanation will be omitted.

The contact image sensor 120 has a micro-lens array 14. The micro-lens array 14 is composed of two micro-lens plates 14a and 14b which are stacked in the focal direction as an upright equipmultiple lens. The micro-lens plates 14a and 14b are prepared by injection-molding a lens plate with a thickness of 2.29 mm using cyclo-olefin resin. On the surfaces of the micro-lens plates 14a and 14b, many micro-lenses 15 are arranged regularly in a two-dimensional shape at a predetermined pitch.

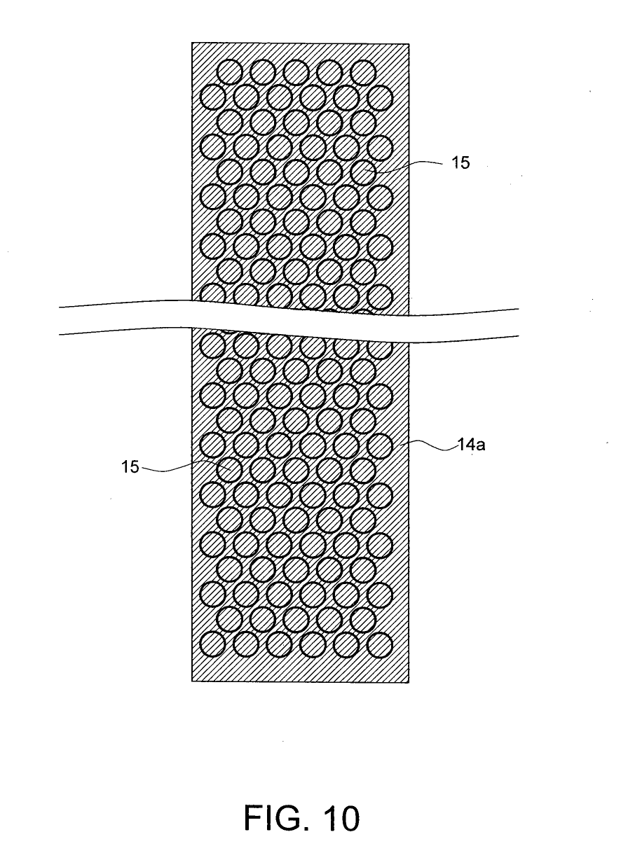

FIG. 10 is a plan view of the micro-lens plate 14a viewed in the focal direction of the lens. The micro-lenses 15 have a lens diameter of 0.35 mm and a radius of curvature of 0.66 mm and are formed on both sides of the micro-lens plate 14a in a hexagonal close-packed arrangement at a lens pitch of 0.45 mm. The micro-lenses 15 on both sides of the micro-lens plate 14a are arranged so that the optical axis of the micro-lens on one surface coincides with the optical axis of the micro-lens on the other surface corresponding to it.

The micro-lens array 14, as shown in FIG. 9, focuses the light irradiated from the LED line flares 40 and 41 and is reflected at the image reading position A of the document 1 onto the light receiving element array 11.

In this case, the micro-lens array 14, since the micro-lenses 15 in a plurality of rows are formed in the sub-scanning direction, can position easily the light receiving element array 11 and can suppress the reduction in the receiving light quantity level of the light receiving element array 11 due to a shift between the optical axis of the lens and the light receiving element array 11.

As explained above, by the contact image sensor (image reading device) relating to this embodiment, the following effects can be obtained.

(6) The micro-lens array 14, due to the shape restrictions, is generally made of resin. The resin lens has a lower transmission factor than a glass lens, thus the light receiving quantity of the light receiving element array 11 lowers. Further, to suppress image noise such as stray light and a ghost image due to the micro-lenses 15 formed in the sub-scanning direction, an aperture angle regulation member having a slit portion is necessary, though it also causes a reduction in the light receiving quantity. Furthermore, compared with the glass lens, the resin lens has a high thermal expansion coefficient, thus the lens characteristics are changed in a high-temperature environment. On the other hand, by use of the constitution of this embodiment, since many micro-lenses 15 are arranged regularly in the two-dimensional shape at a predetermined pitch on the surfaces of the micro-lens plates 14a and 14b, without increasing the light quantities of the LED lie flares 40 and 41, the light quantity of the light receiving element array 11 can be increased. Namely, an occurrence of the above problem can be suppressed without increasing the light quantity of the light source and the image quality can be improved.

(Fourth embodiment) Next, the fourth embodiment of the present invention will be explained. In an image reading device 650 relating to this embodiment, the basic structure is based on the image reading device 550 of the second embodiment. However, a contact image sensor 130 relating to this embodiment is different in the respect that the aperture angle regulation member is not a member composed of a flat plate but a member composed of a triangular prism block.

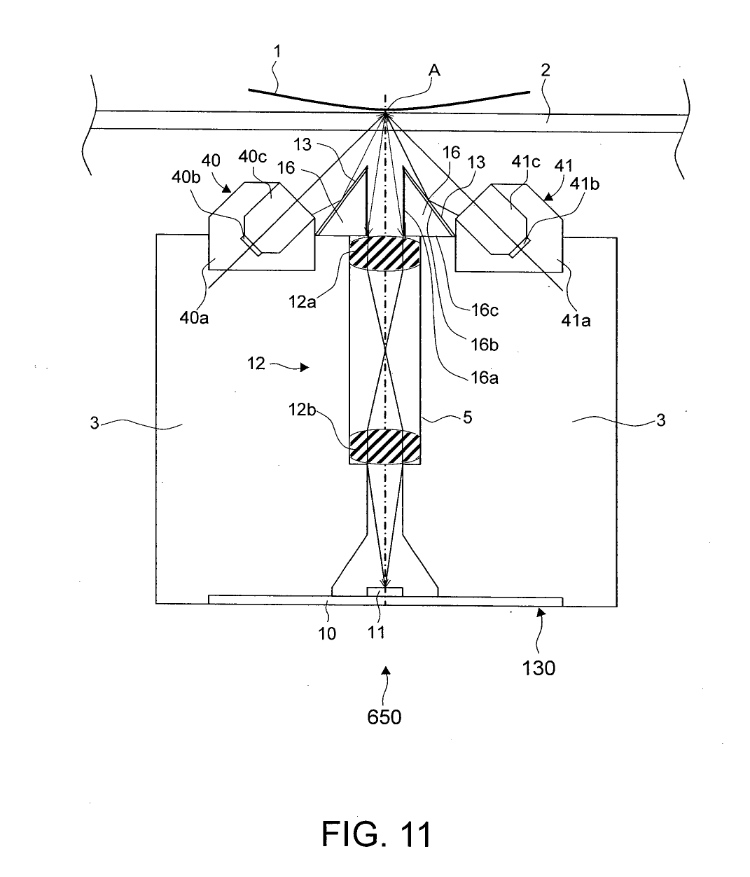

FIG. 11 is a cross sectional view showing the schematic constitution of the contact image sensor relating to the fourth embodiment of the present invention. By referring to the drawing, the constitution of the contact image sensor 130 will be explained below. Further, to the components similar to and based on those of the first embodiment, the same numerals are assigned and the detailed explanation will be omitted.

The contact image sensor 130 has an aperture angle regulation member 16. The aperture angle regulation member 16 is composed of a triangular prism (composed of three side surfaces 16a, 16b, and 16c) metallic block having a black-alumite-treated surface extending in the main scanning direction. This embodiment adopts the aperture angle regulation member 16 which is a triangular prism metallic block (preferably an aluminum bulk), though the present invention is not limited to it and may adopt a hollow metallic block having only the three side surface portions (the side surfaces 16a, 16b, and 16c) of the triangular prism or may adopt a hollow metallic block having only the two side surface portions (the side surfaces 16a and 16b) of the triangular prism which are prepared by folding a flat plate.

On an inclined side surface 16b of the aperture angle regulation member 16 on the side of the LED line flares 40 and 41, the mirrored surface portion 9a or the irregular reflection portion 13 (FIG. 11 shows the irregular reflection portion 13) is installed and it reflects a part of the light irradiated from the LED line flares 40 and 41 to the image reading position A.

In the aperture angle regulation member 16, the angle formed by the side surfaces 16a and 16b forms the aperture angle of the lens array 12a. The lens array 12a supports the end portion of the lens array 12a in the longitudinal direction from underneath by the holding portion (not shown) which is a part of the housing 3.

As explained above, by the contact image sensor (image reading device) relating to this embodiment, the following effects can be obtained.

(7) The aperture angle regulation member 16 is a triangular prism member, so that the aperture angle of the lens array 12a can be regulated by the contact point between the side surface 16a and the lens array 12a. By doing this, among the light entering the lens array 12a, the light at an angle greatly different from the optical axis of the lens is regulated surely, and an occurrence of a ghost image can be suppressed, so that the image quality can be improved.

(8) The aperture angle regulation member 16 is in contact with the lens array 12a, so that it presses the lens array 12a from above by its own weight. By doing this, a load is applied from above to the lens array 12a supported from underneath, so that the lens array 12a is held surely and an occurrence of a displacement can be suppressed.

(9) The aperture angle regulation member 16 is composed of a triangular prism structure, so that structurally, the strength can be improved more than the structure of a flat plate.

(Other embodiments) This contact image sensor is not limited to the structures described in the aforementioned embodiments and within a range which is not deviated from the objects of the present invention, it can be modified variously and for example, it can be executed as the following embodiments.

(a) In all the embodiments aforementioned, it is necessary to respond to each of the two LED line flares 40 and 41, so that a pair of members such as the aperture angle regulation members 8 and 16 are realized, though when only one LED line flare 4 is used, even if one aperture angle regulation member is used, the effects of the present invention can be obtained. In this case, on the side where no LED line flare is installed, the portion of the housing 3 is extended to the glass plate 2. And, by the slit portion formed by the extended portion of the housing 3 and one aperture angle regulation member, the aperture angle of the lens is regulated.

(b) In the embodiments aforementioned, the optical system in which two lens plates (for example, the cylindrical lens 6a and micro-lens plate 14a) extending in the main scanning direction are arranged in the optical axial direction is realized, though an optical system composed of three lens plates arranged in the optical axial direction can obtain the same effects as those of the embodiments aforementioned.

(c) In the embodiments aforementioned, the contact image sensor in the automatic document feeder 400 is installed under the document conveying path, though it is possible to structure so as to install newly a contact image sensor also on the document conveying path and read both surfaces of the document using the upper contact image sensor newly installed and the lower contact image sensor 105. The contact image sensor installed above is installed in the opposite direction to the lower contact image sensor 105 and reads an image on one side of a document conveyed on the document conveying path. Therefore, the upper contact image sensor does not require a glass plate.

(d) In the embodiments aforementioned, the surfaces of the aperture angle regulation members 8 and 16 other than the mirrored surface portion 9a and irregular reflection portion 13, for the purpose of suppressing an occurrence of turbulent light, are subjected to the black alumite treatment so as to absorb light, though by execution of optical painting such as black frosting painting, the same effects can be expected.

(e) In the embodiments aforementioned, the “aperture angle regulation member” of the present invention is realized as an aperture angle regulation member 8 composed of a flat plate folded (refer to FIG. 5). However, even if two flat plates are inclined opposite to each other so as to form the section thereof in a shape of ) the same effects as those of the embodiments aforementioned can be obtained.

(f) In the embodiments aforementioned, the realized “lens” of the present invention is explained using the cylindrical lens 6, lens array 12, and micro-lens array 14 and the realized “inclined surface 9” of the present invention is explained using the mirrored surface portion 9a and irregular reflection portion 13. The present invention is not limited to combination of the “lens” and “inclined surface” explained in the embodiments and for example, a combination of the cylindrical lens 6 and irregular reflection portion 13 and a combination of the micro-lens array 14 and mirrored surface portion 9a are also within the range of the objects of the present invention.

What is claimed is:

1. A contact image sensor comprising:
a housing;
a light source provided on the upper part of the housing to irradiate light to a document;
lenses arranged in the housing and provided at least on an entering side and an outgoing side to focus reflected light from a reading position of the document;
an aperture angle regulation member having an inclined surface to reflect a part of light irradiated from the light source at the reading position of the document and an aperture portion into which the reflected light enters directly to regulate an aperture angle to permit the reflected light passing through the aperture portion to be irradiated to the lens on the entering side; and
a light receiving element array to receive and photoelectrically convert the reflected light focused after passing through the lenses.

2. The contact image sensor according to claim 1, wherein the light source includes a first light source and a second light source.

3. The contact image sensor according to claim 2, wherein the aperture angle regulation member includes a first inclined surface to reflect a part of light irradiated from the first light source at the reading position of the document, a second inclined surface to reflect a part of light irradiated from the second light source at the reading position of the document, an aperture portion provided between the first and second inclined surfaces to permit the reflected light to enter directly, and first and second aperture angle regulation members to regulate an aperture angle to permit the reflected light passing through the aperture portion to be irradiated to the lens on the entering side.

4. The contact image sensor according to claim 1, wherein the inclined surface of the aperture angle regulation member is a mirrored surface portion.

5. The contact image sensor according to claim 1, wherein the inclined surface of the aperture angle regulation member is an irregular reflection portion.

6. The contact image sensor according to claim 1, wherein the aperture angle regulation member is adapted to a triangular member extending in a main scanning direction and a widest surface of the triangular member is the inclined surface.

7. The contact image sensor according to claim 1, wherein the lens is a cylindrical lens arranged in the optical axial direction.

8. The contact image sensor according to claim 1, wherein the lens is lens arrays, stacked in the optical axial direction, composed of lenses arranged in a one-row array shape in a main scanning direction.

9. The contact image sensor according to claim 1, wherein the lens is micro-lens plates, stacked in the optical axial direction, composed of a plurality of micro-lenses arranged regularly in a two-dimensional shape at a predetermined pitch.

10. An image forming apparatus comprising:
an image reading device including a housing, a light source provided on an upper part of the housing to irradiate light to a document, lenses arranged in the housing at least on an entering side and an outgoing side to focus reflected light from a reading position of the document, an aperture angle regulation member having an inclined surface to reflect a part of light irradiated from the light source at the document reading position and an aperture portion to permit the reflected light to enter directly to regulate an aperture angle to permit the reflected light passing through the aperture portion to be irradiated to the lens on the entering side, and a light receiving element array to receive and photoelectrically convert the reflected light focused after passing through the lenses;
a sheet supply portion to store sheets;
an image forming portion to form an image read by the image reading device on a sheet supplied from the sheet supply portion; and
a sheet discharge portion to discharge the sheet with the image formed.

11. The image forming apparatus according to claim 10, wherein the light source includes a first light source and a second light source.

12. The image forming apparatus according to claim 11, wherein the aperture angle regulation member includes a first inclined surface to reflect a part of light irradiated from the first light source at the reading position of the document, a second inclined surface to reflect a part of light irradiated from the second light source at the reading position of the document, an aperture portion provided between the first and second inclined surfaces to permit the reflected light to enter directly, and first and second aperture angle regulation members to regulate an aperture angle to permit the reflected light passing through the aperture portion to be irradiated to the lens on the entering side.

13. An image reading method of a contact image sensor comprising:
irradiating light from a light source toward a document reading position;
focusing reflected light from the document reading position via lenses installed at least on an entering side and an outgoing side;
leading the light from the light source directly to the document reading portion, and reflecting a part of the light from the light source on a inclined surface, which is formed on aperture angle regulation member having an aperture portion to permit the reflected light from the document to enter directly to regulate an aperture angel to permit the reflected light to be irradiated to the lens on the entering side, to lead the light to the document reading portion; and
receiving and photoelectrically converting the reflected light focused when the light led to the document reading position is reflected and passes through the lenses by a light receiving element array.

14. The image reading method according to claim 13, wherein the light source includes a first light source and a second light source.

15. The image reading method according to claim 14, wherein the aperture angle regulation member includes a first inclined surface to reflect a part of light irradiated from the first light source at the reading position of the document, a second inclined surface to reflect a part of light irradiated from the second light source at the reading position of the document, an aperture portion provided between the first and second inclined surfaces to permit the reflected light to enter directly, and first and second aperture angle regulation members to regulate an aperture angle to permit the reflected light passing through the aperture portion to be irradiated to the lens on the entering side.

16. The image reading method according to claim 13, wherein the inclined surface of the aperture angle regulation member is a mirrored surface portion.

17. The image reading method according to claim 13, wherein the inclined surface of the aperture angle regulation member is an irregular reflection portion.

18. The image reading method according to claim 13, wherein the aperture angle regulation member is adapted to a triangular member extending in a main scanning direction and a widest surface of the triangular member is the inclined surface.

19. The image reading method according to claim 13, wherein the lens is a cylindrical lens arranged in the optical axial direction.

20. The image reading method according to claim 13, wherein the lens is lens arrays, stacked in the optical axial direction, composed of lenses arranged in a one-row array shape in the main scanning direction.
